(19) United States
(12) Patent Application Publication
(10) Pub. No.: US 2009/0006198 A1
(43) Pub. Date: Jan. 1, 2009

(54) Product displays for retail stores

(76) Inventors: David George Walsh, Marblehead, MA (US); Dane Allen Poeske, Beverly, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/823,895

(22) Filed: Jun. 29, 2007

(51) Int. Cl. G09F 5/00; G06Q 90/00; G09F 19/02

(52) U.S. Cl. 705/14

(57) ABSTRACT

Displays displaying encased demonstrative products provide shoppers in a retail store an opportunity to inspect a product before purchasing the product.

### FIELD OF THE INVENTION

The present invention is directed to an article suitable shipping and/or displaying products in a retail store.

### BACKGROUND OF THE INVENTION

Palletizable displays displaying retail products in stores are an effective way of shipping products and offering them to shoppers in a retail store. However, there is a continuing need to provide such displays for cross-category products for the convenience of the shopper and to demonstrate synergies or compliments in using these products together in a regimen (such as personal grooming). There is also a need for such displays to allow a shopper to inspect the actual product (verses for example a graphic representation on product packaging/signage) before deciding to purchase the product—particularly when the product is relatively expensive and/or has details that are not readily evident from the product's packaging.

### SUMMARY OF THE INVENTION

The present invention attempts to address these and other needs by providing, in one aspect of the invention, an article for transporting or merchandizing products comprising: a palletizable display comprising displaying: (a) a multiplicity of products, wherein the products are packaged for retail purchase; and (b) an encased demonstrative product, (i) wherein the encased demonstrative product is affixed to the display such that the demonstrative product is not available for retail purchase; and (ii) wherein the demonstrative product of the encased demonstrative product is at least partially encased within a transparent encasing such that the demonstrative product is at least partially viewable by a shopper.

Methods and kits of the same are also provided.

### BRIEF DESCRIPTION OF THE DRAWINGS

FIG. 1 is a perspective view of an example of an article of the present invention comprising an encased demonstrative product (shaver).

FIG. 2 is a closer view of the encased demonstrative product of FIG. 1.

### DETAILED DESCRIPTION OF THE INVENTION

### Definitions:

“Product” means those consumable product(s), that may be perishable or non-perishable, that are typically sold in a retail store. Many products are coded (i.e., product codes) by the use of an UPC (universal product code) or SKU (stock keeping unit). Products can also be characterized by brand name, size, and flavor (e.g., fragrance or taste variety). Exemplary product forms and brands are described at The Procter & Gamble Company's website, www.pg.com, and the linked sites found thereon. In one embodiment the product is a grooming product or a beauty care product. In another embodiment, the product is an oral care product (e.g., toothbrush (manual or motor-driven)).

“Grooming product” means a product that is intended for personal grooming. Non-limiting examples of such products include shaving razors, replacement razors, shaving cream, cologne, aftershave, underarm deodorant, skin moisturizers, hair brush or comb, hair shampoo, hair conditioner, hair colorants, and the like, and combinations thereof. In one embodiment of the invention, a female grooming product or a male grooming product is exclusively provided (i.e., grooming products specifically directed to either males or females).

“Demonstrative product” means a product that is not intended for retail sale, but rather for inspection by a shopper to afford the shopper an opportunity to inspect the product before deciding whether to actually purchase the product. “Inspection,” by the shopper, may be in the form of visual inspection (e.g., observing the ornamental features of the product), or tactile inspection (e.g., feeling the texture of the handle), or a combination thereof.

“Product category” means a multiplicity of products organized by a common theme or purpose. A product category will typically have a multiplicity of product forms and brands. Product categories can be organized by category codes or sub-category codes developed by a retailer or supplier or by the industry as a whole.

“Shopper” is any person (hypothetical or real) that enters a store for the purpose of considering the purchase of a product. A shopper need not actually purchase a product.

“Store” is a retail store, such as WAL-MART or TESCO.

“Display” means a packaging arrangement having a function of containing and/or holding products during shipment and/or to function as a display for those products, typically in a store. Oftentimes, store layouts are arranged in aisles with a special area being reserved, e.g., at the end of each aisle, for standardized product displays. An example of such a display may include one described in US 2005/0067321 A1, published Mar. 31, 2005. A display may comprise shelving to shelve products. The display or shelving may be comprised of paper, cardboard, corrugated paperboard material, plastic, plastic film, or combinations thereof. In one embodiment, the display is suitable for positioning in the “main aisle” or “endcap” of an aisle. In yet another embodiment, the display is a palletizable display. In yet still another embodiment, the article comprises a pallet.

“Palletizable” means capable of being loaded on top of a pallet and shipped via those means known of shipping and moving a loaded pallet. The display may remain on the pallet while in the store and made available to shoppers (i.e., in a shopping area of the store), or the display may be removed from the pallet before being made available to shoppers. The pallet may be comprised of wood, paper, metal, plastic, or combinations thereof. Preferably, the pallet is capable of being moved by a forklift and transported, e.g., by a tractor trailer. Non-limiting examples of pallets may include press pallets, double-sided pallets, stratis paks, roll pallets, racking pallets, nestable pallets, or export pallets. A non-limiting dimension of a pallet is 122 cm×102 cm×15 cm.

In one embodiment, the display of the present invention comprises a foot print area for placement in a retail store comprising from about 0.1 m² to about 6 m², alternatively from about 0.5 m² to about 3 m², alternatively from about 0.75 m² to about 2 m². As such, any two products of the display are within the same foot print area. In another embodiment, more than one display may be palletized on a single pallet.

“Shelving” means any surface or plurality of surfaces oriented to support products in the display ultimately for sale to shoppers. The surface can be any surface found in a retail environment that is suitable for displaying products to shoppers in a shopping area of the store including shelves, hooks, pegboards, or combinations thereof. The shelves of the display can be formed from single integral pieces of foldable materials, such as corrugated board, paperboard, or plastic film which are scored and folded for erection to provide the desired shape and function. In one embodiment, the display comprises 1, 2, 3, 4, 5, 6, 7, 8, or more shelves shelving 1, 2, 3, 4, 5, 6, 7, 8 or more products from 1, 2, 3, 4, 5, 6, 7, or more different product categories. The shelving may further comprise a product dispenser such that once a first product is removed from the shelf (by a shopper), a second product is automatically filled to where the first product was positioned (by gravity feed or spring feed or the like). An example of such a product dispenser may include one that is described in U.S. Pat. No. 6,991,116; or U.S. Pat. No. 7,213,722. In one embodiment, the product dispenser further comprises a product dispensing delaying mechanism (see e.g., U.S. Pat. No. 7,213,722). Without wishing to be bound by theory, the “delay” (e.g., 3-5 seconds) acts as deterrent to theft, since the potential thief must wait for each product to be dispensed.

### Display Displaying Products for Sale and an Encased Product for a Shopper's Inspection

One aspect of the invention provides for an article for transporting or merchandising products comprising: a palletizable display comprising displaying: (a) a multiplicity of products (preferably where the products are from two or more different product categories), wherein the products are packaged for retail purchase; and (b) an encased demonstrative product, (i) wherein the encased demonstrative product is affixed to the display such that the demonstrative product is not available for retail purchase; and (ii) wherein the demonstrative product of the encased demonstrative product is at least partially encased within a transparent encasing such that the demonstrative product is at least partially viewable by a shopper.

“Encased” means to enclose, envelop, encase, or the like, the demonstrative product with a material, such as a transparent plastic (e.g., polypropylene or polyethylene terephthalate or other thermoplastic polymer resins), to form a barrier (preferably a rigid barrier or substantially rigid) between the demonstrative product and the shopper. The encasing may be formed, for example, by molding or blow molding. The barrier is such that it functions to restrict, or at least partially restrict, tactile access by the shopper to the demonstrative product while the shopper is inspecting the product. The term “transparent” means the shopper is able to view the product through the encasing material, such encasing material having enough transparency, such that the shopper is capable of visually inspecting the demonstrative product.

In one embodiment, the encasing may have one or more apertures to allow the shopper access or at least partial access to the demonstrative product such the shopper may touch (e.g., with fingers) certain aspects of the product (e.g., texture of a handle of a shaving razor) but yet the encasing may restrict access to other aspects of the product (e.g., the sharp edge of a razor for the safety's sake of the shopper).

In another embodiment, a mirrored surface is provided as part of the encasing or display itself as a means to allow the shopper to inspect a portion of the product that is not readily visible from looking at the product from a single perspective view and/or simply as a means of drawing attention to the product/product display given the reflective properties of the mirrored surface.

In yet another embodiment, part of the encasing is transparent while other parts of the encasing may be non-transparent. Such an approach may focus the shopper to a new feature of the product or showcase an advantage of the product over that of a competitive product. Different or additional materials for the encasing, or selective use of dyes/colorants, or combinations thereof, may be used for this mixed translucent/non-translucent effect of the encasing.

In yet another embodiment, the encasing forms a sphere or partial sphere or some other shape (e.g., geometric shape) distinct from the product. In another embodiment, the shape of the encasing is one that contours or substantially contours (in part or as a whole) the shape of the demonstrative product. For example, the encasing may mirror the shape of a handle of a shaving razor but then form a sphere around the blade portion of the shaving razor in an effort, for example, to bring attention to the blade portion.

In yet another embodiment, more than one demonstrative product is provided within a single encasing, preferably where each demonstrative product is positioned such that alternative views are provided to the shopper for inspection. For example, a first demonstrative product is provided with a front view of the product exposed to the consumer, while a second demonstrative product is provided with a side view of the product.

In yet still another embodiment, more than one encased demonstrative product is provided on the display. For example, an encased product (the same product or different product) is provided on either side of the display to allow more than one shopper to inspect the demonstrative product.

“Viewable by a shopper” means the demonstrative product of the encased demonstrative product is visually inspectable by the shopper. Without wishing to be bound by theory, many shoppers want to inspect a product before committing to purchase the product—particularly when the product is relatively expensive (e.g., manually shaving razor may retail as high as $12 or more) and/or is new or offers a new benefit. Allowing the shopper to inspect the demonstrative product may remove these or other purchase barriers and may also reduce the number of products that are unpackaged by shoppers for inspection (reducing the number of products that are available for sale).

“Encased demonstrative product is affixed to the display” means that the encased demonstrative product (e.g., shaving razor) is attached to the display in a permanent or semi-permanent manner to discourage shoppers from removing the product (so as to allow subsequent shoppers to inspect the product). The means of attachment is by those known in the art, of course taking into account, e.g., shapes and materials of the product/encasing/display, and the like. For example, glues, adhesives, or even a tether (e.g., such tether composed of a wire or string) may be used to affix the encased demonstrative product to the display.

In one embodiment, the encased demonstrative product, or the product of the encased demonstrative product, comprises at least one axis of rotation wherein the encased product or products is rotatable around that axis. For example, a rod may traverse through the encased product (e.g., the rod being perpendicular to the store's floor) or simply a part of a rod is affixed on either end of the encased product, thereby allowing the shopper to rotate the encased product (e.g., 45°, 90°, 180°, or 360°, or the like) to inspect the product. Of course there may be more than one axis of rotation, and other joints or points of flexion may be provided in lieu of or in addition to a rod.

In one embodiment, the encased product is affixed to the display such that it is positioned from about 3 feet to about 6 feet, alternatively from about 4 feet to about 5 feet, relative from the floor of the store. Without wishing to be bound by theory, such a height provides the correct ergonomical level of comfort to shopper when inspecting the product of the encased product (ostensibly avoiding back pain from bending over or neck pain from looking up).

“Not available for retail purchase” means the demonstrative product, as is it presented on the display, would be apparent to most shoppers that the product is not available for purchase but rather is presented as a “sample” for inspection by the shopper.

Another aspect of the invention provides the article to further comprise a magnifier, preferably where the magnifier is associated with the encased product. “Magnifier” means an article comprising a magnifying lens (comprising of glass, plastic, and the like) is capable of assisting a shopper to inspect details of a demonstrative product that may not be readily apparent from an unaided visual inspection, or assist those with viewing challenges (e.g., senior citizen). The magnifier may be integral to the encasing or non-integral to the encasing (e.g., affixed to the display by a tether). In turn, “associated with the encased product” means the magnifier is localized in such a proximity and manner that a shopper may use the magnifier to inspect the demonstrative product of the encased demonstrative product.

### Array of Products

One aspect of the invention provides an article comprising an array of products for sale, alternatively an array of grooming products, alternatively an array of products for use in a multi-category regimen. The term, “multi-category regimen” means at least two products from two different product categories, that are each used to accomplish a common task. Non-limiting examples of such tasks include: personal hygiene, personal care, home care, fabric care, hair care, skin care, baby or child care, baby or child hygiene care.

In one embodiment, the array of products of a multi-category regimen is for male grooming. For example, the array of products in display include the products that a male may use in the morning as part of a grooming regimen, such as a manual shaving blade razor (with or without replacement razor blades) for shaving his face, shaving gel (the term “gel” used broadly to also include shaving foams and the like) in preparing his face for shaving, underarm deodorant for personal malodor control, and potentially other products (after-shave and skin moisturizers and the like). Alternatively, the shaver may be a rechargeable dry “electric shaver”

In one embodiment, the display displaying the array of products organizes the products by benefits, scents, sizes, and other variables that characterize the products of the product category. These variables may include, for example, with respect to manual shaving razors, how many razor blades are found on the shaver (e.g., 1, 2, 3, etc.); how many cartridges are found in a package of replacement razor blade cartridges; what benefits or scents are associated with a shaving gel or underarm deodorant (e.g., moisturizing, sensitive skin, etc); scents associated with a deodorant. The products displayed on the display may be organized in many ways known in the art to help facilitate the shopper to identify the product that best suits the shopper (e.g., by grouping the product in a single product category together, color coding, signage, etc).

Without wishing to be bound by theory, merchandizing the array of products in a single display provides the convenience for the shopper to address all their needs for a regimen in a single location. There is also an opportunity for the manufacturer to coordinate multiple products together to showcase “synergies” or “compliments” in using the products together in a regimen (e.g., using the same scent for multiple product categories etc.). The palletizable display may be localized in the area of the store away from where the products are “traditionally” sold in order to drive awareness with shopper (with benefit of driving incremental sales).

In one embodiment, the article comprises at least 1 product, alternatively at 5, or 10, or 15, or 20, or 30, or more products of a product category or even specific product type (e.g., scent or flavor or size). The article may comprise at least 1, or 2, or 3, or 4, or 5, or 6, or 7, or 8, or 9, or 10, or more products of a product category or specific product type.

### Signage

One aspect of the invention provides the use of signage on the article to draw attention to the product(s) being sold on the display. In one embodiment, a graphic representation of the demonstrative article is provided on the signage to call attention to the product. In another embodiment, the graphic representation is 2, 3, 4, 5, 6, 7, 8-fold, or more, larger than the physical form of the demonstrative product. The larger size of the graphic allows a shopper to see what is offered by display, from a distance, and may also be used to call attention to a new feature or benefit of the product. Thus, signage (with a graphic (e.g., pictorial graphic) of the product) together with the encased demonstrative product may provide the “holding power” to ideally market and sell the product to shoppers. The signage is able to draw the attention of the shopper from afar whereas the encased demonstrative product is available for inspection by shopper in a close proximity to the display. The signage, of course, may be placed in the front of the display (as a header, banner, footer, and the like) or the side(s) of the display.

In one embodiment, the signage is provided in a curvilinear manner in effort to increase the surface area as well as provide visibility from a variety of angles (which the shopper may approach the display or view the display).

In another embodiment, the signage comprises an electrophoretic display (alternatively an encapsulated electrophoretic display) or an electroluminescent display to help solicit the shopper's attention while shopping. Further details regarding encapsulated electrophoretic displays may be described in U.S. Pat. Nos. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,721; 6,252,564; 6,262,706; and 6,262,833. Details regarding electroluminescent displays may be described in U.S. Pat. Nos. 4,982,135; 5,053,675; 5,075,596; 5,179,316; 5,416,494; 5,598,058; 5,634,835; 5,660,697; 5,917,278; 5,972,419; 6,014,116; 6,091,384; 6,111,063; 6,137,222; 6,274,985; 6,373,454; 6,390,874; 6,400,348; 6,452,576; 6,501,218; 6,624,571; 6,693,610; 6,751,898; 6,808,828; 6,876,145; 6,882,106; 6,888,318; 6,911,960; 6,943,496; 6,960,890; 6,982,180; 6,987,356; 6,992,437; 7,025,650; 7,034,455; 7,064,350; 7,064,482; 7,102,198; 7,105,999; 7,106,001; 7,109,522; 7,122,959; 7,161,293; 7,173,378; 7,187,120; 7,187,133; 7,202,840 and 7,205,572.

In yet another embodiment, the article comprises a compact flashcard player. A compact flashcard player may be a cost effective alternative to DVD or personal computer based system. The display may comprise peripheral devices such as interactivity system, such as a touch membrane/touch screen or an UPC barcode scanner.

### Modular Assembly

Another aspect of the invention provides for the article to comprise a modular design where multiple displays are arranged next to each other in the store for the shopper—in a main aisle or promotional area. The display can be delivered in a single pallet or multiple pallets with one or more displays palletized on a single pallet (with potential multiple pallets delivering the various modularized components). This modular approach may provide benefits such as providing an easier (and potentially more compliant) manner of stocking products and/or providing an entire category solution (e.g., total grooming solution) that potentially includes products from many different product manufacturers. In one embodiment, the individual displays of the modular assembly each have graphics and/or signage that are coordinated such that when the displays are fully assembled/aligned with each other, the collective modular assembly connotes a single coordinated message to the shopper. For example, each display may have a part of a whole image, but when all the displays are placed together in the desired manner, a single image is displayed.

### EXAMPLE

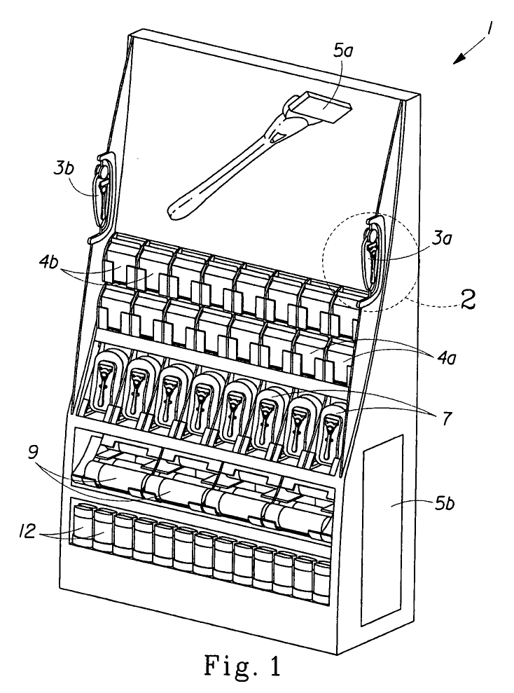

FIG. 1 is a palletizable display 1 comprising male grooming products. These male grooming products comprise replacement razor blade cartridges 4a, 4b. The two rows of cartridges 4a, 4b may be organized by the number razors in a package (not shown) and whether the cartridges are directed to manual or battery-powered razors (not shown) with signage indicating as such (not shown). The male grooming product may also comprise shavers 7 (to which the cartridges 4a, 4b are directed). The products also include cans of shaving gel 9, potentially organized by scent (not shown) with signage indicating as such (not shown). Lastly, a row of under arm deodorant 12 is also displayed (which also by organized by scent/signage (not shown)).

The display 1 of FIG. 1 has two encased demonstrative shavers 3a, 3b displayed on either side of the display 1. Signage 5a, 5b reflecting a picture of the shaver 5a is in the front of the display 1 whereas the “brand name” of the razor 5b is on a side of the display. The display 1 is about 36 inches wide, about 18 inches in depth, and about 74 inches tall.

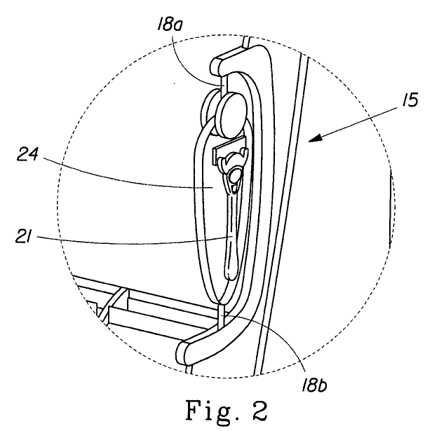

FIG. 2 is an encased demonstrative shaver 15. The demonstrative shaver 21 is encased 24 in an encasing of translucent plastic. Pins 18a, 18b on either end of the encased demonstrative shaver 15 provide an axis to which the shopper may rotate the encased demonstrative product a full 360° for inspection.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article for transporting or merchandizing products comprising: a palletizable display comprising:
(a) a multiplicity of grooming products from at least two different product categories, wherein the grooming products are packaged for retail purchase; and
(b) an encased shaving razor,
(i) wherein the encased shaving razor is affixed to the palletizable display such that the shaving razor is not available for retail purchase; and
(ii) wherein the shaving razor of the encased shaving razor is at least partially encased within a transparent encasing such that the shaving razor is at least partially viewable by a shopper.

2. The article of claim 1, wherein the display further comprises a plurality of shelves, wherein the grooming product is shelved on at least one shelf of the plurality of shelves.

3. The article of claim 1, wherein the encased shaving razor is rotatable around an axis.

4. The article of claim 3, wherein the axis is substantially perpendicular to a store's floor.

5. The article of claim 1, wherein the article further comprises a magnifier.

6. The article of claim 5, wherein the magnifier is associated with the encased shaving razor, and wherein at least part of the razor is viewable through the magnifier by a shopper.

7. The article of claim 1, wherein the grooming products comprise a male grooming product array, wherein the products are chosen from product categories of a shaving gel, blade shavers, blade cartridges, underarm deodorant, and combinations thereof.

8. The article of claim 1, wherein the grooming products comprise a male grooming product array, wherein there is a least one product from each of the following product categories a shaving gel, blade shaver, blade cartridge, and underarm deodorant.

9. The article of claim 3, wherein the grooming products comprise a male grooming product array, wherein there is a least one product from each of the following product categories a shaving gel, blade shaver, blade cartridge, and underarm deodorant.

10. The article of claim 6, wherein the grooming products comprise a male grooming product array, wherein there is a least one product from each of the following product categories a shaving gel, blade shaver, blade cartridge, and underarm deodorant.

11. The article of claim 1, further comprising a pallet.

12. An article for transporting or merchandizing products comprising: a palletizable display comprising:
(a) a multiplicity of products, wherein the products are packaged for retail purchase; and
(b) an encased demonstrative product;
(i) wherein the encased demonstrative product is affixed to the display such that the demonstrative product is not available for retail purchase; and
(ii) wherein the demonstrative product of the encased demonstrative product is at least partially encased within a transparent encasing.

13. The article of claim 12, wherein the demonstrative product is a health or beauty care product.

14. The article of claim 13, wherein the article further comprises a magnifier capable of magnifying the demonstrative product.

15. The article of claim 13, wherein the encased demonstrative product is rotatable, at least 180°, around an axis.

16. The article of claim 15, wherein the axis is substantially perpendicular to a store's floor.

17. The article of claim 12, wherein the article further comprises at least two encased demonstrative products.

18. The article of claim 17, wherein the demonstrative product comprises a health or beauty care product.

19. The article of claim 18, wherein at the encased demonstrative product is rotatable 360° around an axis.

20. A method of selling a razor comprising the step of displaying the article of claim 1 in a shopping area of a store.
